(19) United States
(12) Patent Application Publication
(10) Pub. No.: US 2020/0278673 A1
(43) Pub. Date: Sep. 3, 2020

(54) INFORMATION PROCESSING APPARATUS AND FLIGHT CONTROL SYSTEM

(71) Applicant: NTT DOCOMO, INC., Tokyo (JP)

(72) Inventors: Hiroshi Nakagawa, Tokyo (JP); Kazuhiro Yamada, Tokyo (JP)

(73) Assignee: NTT DOCOMO, INC., Tokyo (JP)

(21) Appl. No.: 16/754,240

(22) PCT Filed: Oct. 24, 2018
(86) PCT No.: PCT/JP2018/039476

§ 371 Date: Apr. 7, 2020

(30) Foreign Application Priority Data
Oct. 30, 2017 (JP) 2017-209454

(51) Int. Cl. G05D 1/00; G05D 1/10; B64C 39/02; H04W 4/40

(52) U.S. Cl. CPC G05D 1/0022; G05D 1/005; B64C 2201/146; B64C 39/024; H04W 4/40; G05D 1/101

(57) ABSTRACT

The present invention makes it possible to provide piloting assistance to a pilot of a flight vehicle from a remote location. A server apparatus functions as a control platform for controlling the flight of the flight vehicle. Specifically, flight control is performed in which the server apparatus determines whether a first piloting terminal operated by a pilot or a second piloting terminal operated by a piloting assister is to pilot the flight vehicle, and in a case of determining that the second piloting terminal is to pilot the flight vehicle, the server apparatus transfers commands for the flight vehicle that are received from the second piloting terminal to the flight vehicle.

### TECHNICAL FIELD

The present invention relates to providing piloting assistance for a pilot of a flight vehicle.

### BACKGROUND ART

As one example of technology for controlling a flight vehicle, JP 2014-104797A discloses a system in which light emitted from a light emitter provided in a flight vehicle is tracked by a camera provided on a moving mechanism in order to capture images of the flight state of the flight vehicle, and the captured images are displayed at a remote location.

### SUMMARY OF INVENTION

### Technical Problem

Various types of services that employ flight vehicles called drones have become prevalent in recent years. Under such circumstances, consideration is being given to systems for remotely providing piloting assistance to a pilot who is inexperienced with the piloting of a flight vehicle. In view of this, an object of the present invention is to provide a system that can provide piloting assistance to a pilot of a flight vehicle from a remote location.

### Solution to Problem

In order to solve the foregoing problems, the present invention provides an information processing apparatus including: a first communication unit configured to perform communication with a first piloting terminal that is for wirelessly piloting a flight vehicle; a second communication unit configured to perform communication with a second piloting terminal that is for piloting the flight vehicle via a network; a determination unit configured to determine whether the first piloting terminal or the second piloting terminal is to pilot the flight vehicle based on information that the first communication unit receives from the first piloting terminal or information that the second communication unit receives from the second piloting terminal; and a remote control unit configured to, in a case where it is determined that the second piloting terminal is to pilot the flight vehicle, transfer an instruction for the flight vehicle that is received from the second piloting terminal to the flight vehicle.

An aspect is possible in which in a case where it is determined that the second piloting terminal is to pilot the flight vehicle, the remote control unit uses the first communication unit to notify the first piloting terminal that the second piloting terminal is to pilot the flight vehicle, and if permission is received in response to the notification, the remote control unit transfers an instruction for the flight vehicle that is received from the second piloting terminal to the flight vehicle.

An aspect is possible in which the determination unit specifies a piloting experience level with respect to the first piloting terminal based on information that the first communication unit receives from the first piloting terminal or information that the second communication unit receives from the second piloting terminal, and makes the determination based on the experience level.

An aspect is possible in which the determination unit specifies a flight environment of the flight vehicle based on information that the first communication unit receives from the first piloting terminal, and makes the determination based on the flight environment.

An aspect is possible in which the determination unit specifies a state of the flight vehicle based on information that the first communication unit receives from the first piloting terminal, and makes the determination based on the state.

An aspect is possible in which the first communication unit and the second communication unit relay audio communication between the first piloting terminal and the second piloting terminal, and information that the first communication unit receives from the first piloting terminal is output by audio with use of the second communication unit.

An aspect is possible in which in a case where there are a plurality of sets of the first piloting terminal and the second piloting terminal, the determination unit makes the determination for each set of the first piloting terminal and the second piloting terminal, and for each set of the first piloting terminal and the second piloting terminal, in a case where it is determined that the second piloting terminal is to pilot the flight vehicle, the remote control unit transfers an instruction for the flight vehicle that is received from the second piloting terminal to the flight vehicle.

The present invention also provides a flight control system including: a first piloting terminal for wirelessly piloting a flight vehicle; a second piloting terminal for piloting the flight vehicle via a network; a first communication unit configured to perform communication with the first piloting terminal; a second communication unit configured to perform communication with the second piloting terminal; a determination unit configured to determine whether the first piloting terminal or the second piloting terminal is to pilot the flight vehicle based on information that the first communication unit receives from the first piloting terminal or information that the second communication unit receives from the second piloting terminal; and a remote control unit configured to, in a case where it is determined that the second piloting terminal is to pilot the flight vehicle, transfer an instruction for the flight vehicle that is received from the second piloting terminal to the flight vehicle.

According to the present invention, it is possible to provide piloting assistance to a pilot of a flight vehicle from a remote location.

### BRIEF DESCRIPTION OF DRAWINGS

FIG. 1 is a diagram showing an example of the configuration of flight control system.

FIG. 2 is a diagram showing an example of the appearance of flight vehicle.

FIG. 3 is a diagram showing a hardware configuration of flight vehicle.

FIG. 4 is a diagram showing a hardware configuration of first piloting terminal.

FIG. 5 is a diagram showing a hardware configuration of second piloting terminal.

FIG. 6 is a diagram showing a hardware configuration of server apparatus.

FIG. 7 is a diagram showing an example of the functional configuration of server apparatus.

FIG. 8 is a diagram showing an example of a display image determination table.

FIG. 9 is a diagram showing an example of a main pilot determination table.

FIG. 10 is a sequence chart showing an example of operations of flight control system.

### DETAILED DESCRIPTION OF PREFERRED EMBODIMENTS

### Configuration

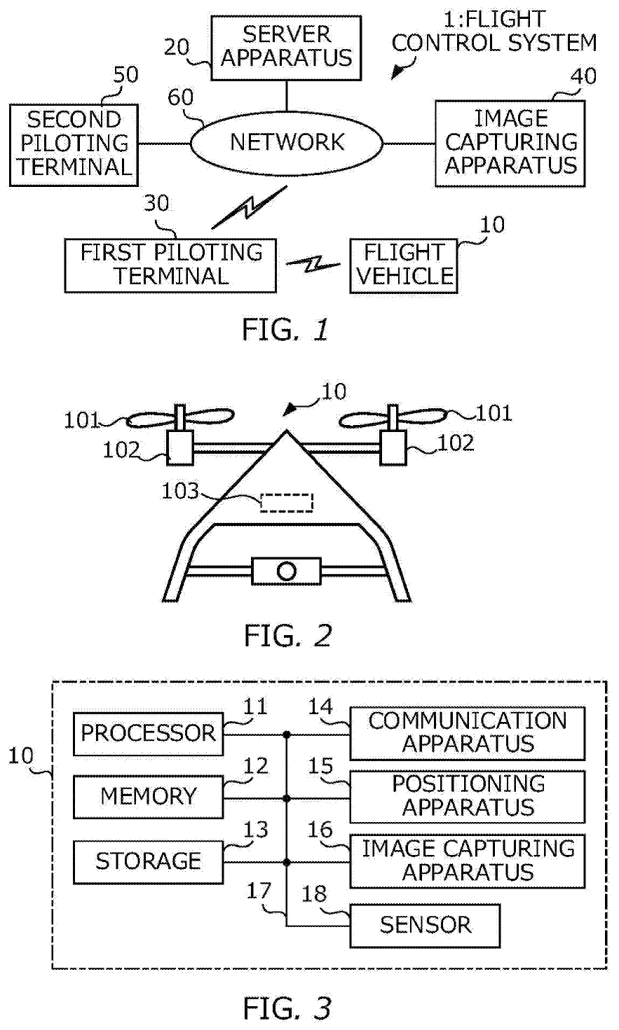

FIG. 1 is a diagram showing an example of the configuration of flight control system 1. Flight control system 1 is a system for controlling the flight of flight vehicle 10. Flight control system 1 includes flight vehicle 10, server apparatus 20, first piloting terminal 30, image capturing apparatus 40, second piloting terminal 50, and network 60. Flight vehicle 10 is a flight-capable apparatus called a drone for example, and includes an image capturing function for capturing a moving image of its surroundings. The images captured with this image capturing function are images from the viewpoint of flight vehicle 10, and will hereinafter be called flight vehicle viewpoint images.

First piloting terminal 30 is a terminal for allowing a pilot to pilot flight vehicle 10 while viewing flight vehicle 10. First piloting terminal 30 is wirelessly connected to flight vehicle 10 and gives operation instructions thereto by transmitting wireless signals that correspond to operations performed by the pilot to the flight vehicle 10.

Image capturing apparatus 40 is a camera for example, and captures a moving image of the flight of flight vehicle 10. This image capturing apparatus 40 includes pan and tilt functions, and by using image recognition technology to analyze the captured images and recognize flight vehicle 10 in the captured images, and then controlling the pan and tilt functions, image capturing apparatus 40 can change the shooting direction during image capturing so as to follow the recognized flight vehicle 10. This image capturing apparatus 40 may be a fixed image capturing apparatus that is disposed on the ground below the airspace of flight vehicle 10, or may be a portable image capturing apparatus that can be carried by a person. In the present embodiment, image capturing apparatus 40 is portable, and is placed near the pilot and captures images of the space including flight vehicle 10. The images captured by image capturing apparatus 40 include substantially the same field of view as the case of viewing the flight of flight vehicle 10 from the viewpoint of the pilot, and will hereinafter be called pilot viewpoint images.

Second piloting terminal 50 is a terminal for allowing a piloting assister to remotely assist the piloting of the flight vehicle by the pilot. Second piloting terminal 50 includes a display function and can display the aforementioned flight vehicle viewpoint images or pilot viewpoint images. The piloting assister assists the piloting performed by the pilot, by operating second piloting terminal 50 while viewing such images. Here, with respect to a piloting experience level that indicates the amount of piloting experience, it is presumed that the piloting assister who is operating second piloting terminal 50 has a higher piloting experience level than the pilot who is operating first piloting terminal 30.

Server apparatus 20 is an information processing apparatus that functions as a control platform for controlling the flight of flight vehicle 10. Server apparatus 20 performs flight control by determining whether the piloting of flight vehicle 10 is to be performed by first piloting terminal 30 operated by the pilot or second piloting terminal 50 operated by the piloting assister, and in a case of determining that the piloting of flight vehicle 10 is to be performed by second piloting terminal 50, then transferring commands for flight vehicle 10 received from second piloting terminal 50 to flight vehicle 10.

Also, server apparatus 20 causes either the flight vehicle viewpoint images captured through the image capturing function of flight vehicle 10 or the pilot viewpoint images of the flight of flight vehicle 10 captured by image capturing apparatus 40 to be displayed with priority on second piloting terminal 50. Here, “displayed with priority” means that the one type of captured images that are to be displayed with priority will be displayed on second piloting terminal 50 in a manner of being more visible or comprehensible to the user than the other type of captured images, and examples of this include an aspect for displaying the priority captured images and not displaying the other captured images, an aspect for displaying the priority captured images at a larger size than the other captured images, an aspect for displaying the priority captured images at an earlier time than the other captured images, and an aspect for displaying the priority captured images in a more visually emphasized manner than the other captured images.

Server apparatus 20, first piloting terminal 30, image capturing apparatus 40, and second piloting terminal 50 are connected wirelessly or by wire in network 60 so as to be able to communicate with each other. In order to realize low-latency data transfer, it is desirable that network 60 is a closed network.

FIG. 2 is a diagram showing an example of the appearance of flight vehicle 10. Flight vehicle 10 is also called a drone for example, and includes propellers 101, driving apparatuses 102, and battery 103.

Propellers 101 rotate around shafts. Flight vehicle 10 flies due to rotation of propellers 101. Driving apparatuses 102 give motive power to propellers 101 to cause rotation thereof. Driving apparatuses 102 each include a motor and a transmission mechanism for transmitting motive power from the motor to the propeller 101, for example. Battery 103 supplies electric power to units of flight vehicle 10, including driving apparatuses 102.

FIG. 3 is a diagram showing the hardware configuration of flight vehicle 10. Flight vehicle 10 is physically configured as a computer apparatus that includes processor 11, memory 12, storage 13, communication apparatus 14, positioning apparatus 15, image capturing apparatus 16, sensor 18, bus 17, and the like. Note that in the following description, the term “apparatus” can be replaced with terms such as circuit, device, and unit.

Processor 11 runs an operating system and performs overall control of the computer, for example. Processor 11 may be configured by a CPU (Central Processing Unit) that includes a control apparatus, an arithmetic operation apparatus, a register, an interface for peripheral apparatuses, and the like.

Also, processor 11 reads out programs (program code), software modules, and data from storage 13 and/or communication apparatus 14 to memory 12, and accordingly executes various types of processing. One program is a program for causing the computer to execute at least part of the operations of flight vehicle 10. The various types of processing executed in flight vehicle 10 may be executed by one processor 11, or may be executed by two or more processors 11 simultaneously or consecutively. Processor 11 may be mounted on one or more chips. Note that the program may have been transmitted from the network via an electrical communication line.

Memory 12 is a computer-readable recording medium, and may be configured by one or more of a ROM (Read Only Memory), an EPROM (Erasable Programmable ROM), an EEPROM (Electrically Erasable Programmable ROM), a RAM (Random Access Memory), and the like. Memory 12 may be called a register, a cache, a main memory (main storage apparatus), or the like. Memory 12 can hold, for example, software modules and programs (program code) that can be executed in order to carry out a flight control method according to an embodiment of the present invention.

Storage 13 is a computer-readable recording medium, and may be configured by at least one of an optical disc such as a CD-ROM (Compact Disc ROM), a hard disk drive, a flexible disk, a magneto-optical disk (e.g., a compact disk, a digital versatile disk, or a Blu-ray (registered trademark) disk), a smart card, a flash memory (e.g., a card, a stick, or a key drive), a Floppy (registered trademark) disk, and a magnetic strip. Storage 13 may also be called an auxiliary storage apparatus.

Communication apparatus 14 is hardware for performing wireless communication with first piloting terminal 30.

Positioning apparatus 15 measures the three-dimensional position of flight vehicle 10. For example, positioning apparatus 15 is a GPS (Global Positioning System) receiver and measures the current position of flight vehicle 10 based on GPS signals that are received from a plurality of satellites.

Image capturing apparatus 16 captures images of the surroundings of flight vehicle 10. For example, image capturing apparatus 16 is a camera, and captures images by forming an image on an imaging element with use of an optical system. Image capturing apparatus 16 captures images of a predetermined range in front of flight vehicle 10 for example. It should be noted that the image capturing direction of image capturing apparatus 16 is not limited to being in front of flight vehicle 10, and may be above, below, or behind flight vehicle 10. Also, the image capturing direction may be changed by rotation of a platform that supports image capturing apparatus 16, for example.

Sensor 18 is a device for sensing various states of flight vehicle 10, and detects the altitude of flight vehicle 10, the speed of flight vehicle 10, the orientation of flight vehicle 10, the battery amount of flight vehicle 10, the motor rotation speeds of flight vehicle 10, and the distance between flight vehicle 10 and a work object, for example. Note that in the case where flight vehicle 10 is capturing images of a building for example, the work object is that building.

Apparatuses such as processor 11 and memory 12 described above are connected by bus 17 in order to exchange information. Bus 17 may be configured by a single bus, or may be configured by different buses that connect apparatuses.

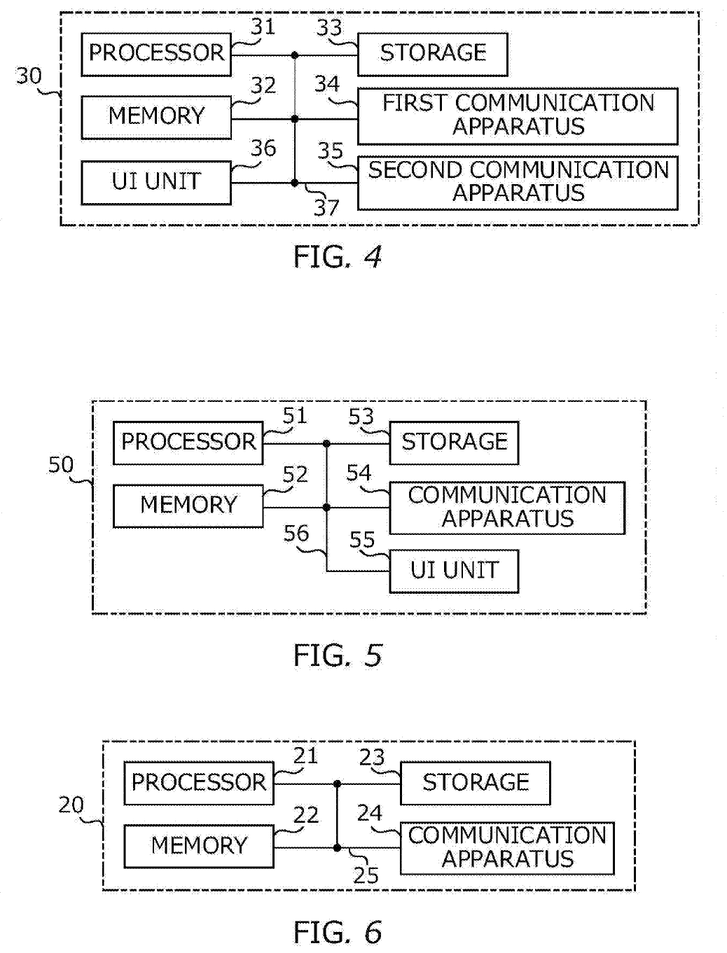

FIG. 4 is a diagram showing the hardware configuration of first piloting terminal 30. First piloting terminal 30 is physically configured as a computer apparatus that includes processor 31, memory 32, storage 33, first communication apparatus 34, second communication apparatus 35, UI (User Interface) unit 36, bus 37, and the like. First communication apparatus 34 performs wireless communication with communication apparatus 14 of flight vehicle 10. Second communication apparatus 35 performs communication with server apparatus 20 via network 60. UI unit 36 includes a display unit that has a liquid crystal panel, a liquid crystal drive circuit, and the like, and displays images based on image data, and also includes an operation unit that has operators such as keys or a touch sensor and receives user operations and supplies signals corresponding to such operations to processor 31. The other units, namely processor 31, memory 32, storage 33, and bus 37, are similar to processor 11, memory 12, storage 13, and bus 17 that were described above, and therefore descriptions will not be given for them.

FIG. 5 is a diagram showing the hardware configuration of second piloting terminal 50. Second piloting terminal 50 is physically configured as a computer apparatus that includes processor 51, memory 52, storage 53, communication apparatus 54, UI unit 55, bus 56, and the like. Communication apparatus 54 performs communication with server apparatus 20 via network 60. The other units, namely processor 51, memory 52, storage 53, UI unit 55, and bus 56, are similar to processor 11, memory 12, storage 13, UI unit 36, and bus 17 that were described above, and therefore descriptions will not be given for them.

FIG. 6 is a diagram showing the hardware configuration of server apparatus 20. Server apparatus 20 is physically configured as a computer apparatus that includes processor 21, memory 22, storage 23, communication apparatus 24, bus 25, and the like. Communication apparatus 24 performs communication with first piloting terminal 30 and second piloting terminal 50 via network 60. Processor 21, memory 22, storage 23, and bus 25 are similar to processor 11, memory 12, storage 13, and bus 17 that were described above, and therefore descriptions will not be given for them.

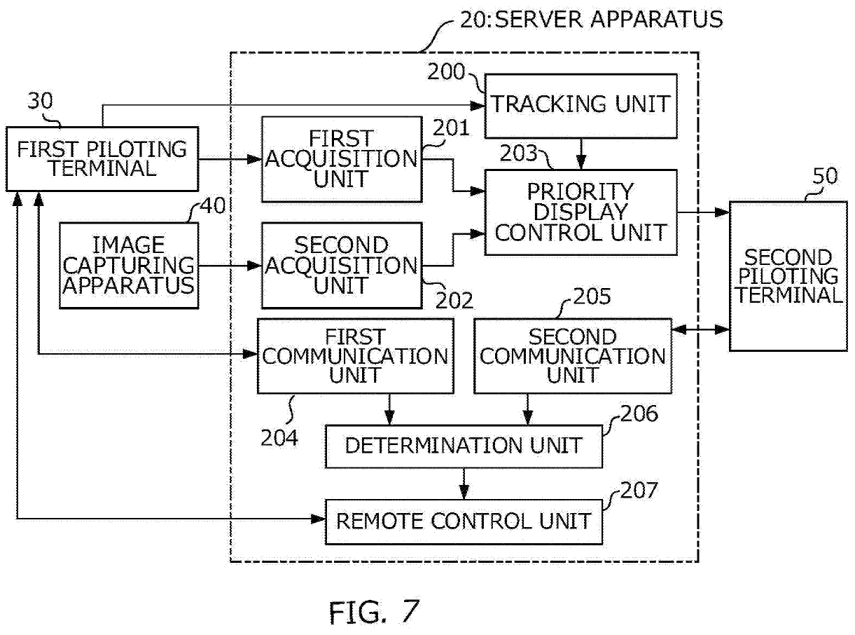

FIG. 7 is a diagram showing an example of the functional configuration of server apparatus 20. Various functions of server apparatus 20 are realized by predetermined software (program) being loaded to hardware such as processor 21 and memory 22, such that processor 21 performs arithmetic computation and controls communication performed by communication apparatus 24 and the reading and/or writing of data from/to memory 22 and storage 23.

In FIG. 7, tracking unit 200 records flight vehicle identification information corresponding to flight vehicle 10 that is under control of server apparatus 20, and also records the flight status of flight vehicle 10. The flight status includes positions at which flight vehicle 10 is flying, and date/times of such positions. Tracking unit 200 records position information and date/time information that are notified by flight vehicle 10 via first piloting terminal 30. Tracking unit 200 also determines whether or not the position information and the date/time information are within a flight plan that has been planned in advance, and records the determination results.

First acquisition unit 201 acquires, via first piloting terminal 30, flight vehicle viewpoint images that were captured by image capturing apparatus 16 included in flight vehicle 10. Second acquisition unit 202 acquires, from image capturing apparatus 40, pilot viewpoint images of the flight of flight vehicle 10 captured by image capturing apparatus 40.

Priority display control unit 203 causes either the flight vehicle viewpoint images acquired by first acquisition unit 201 or the pilot viewpoint images acquired by second acquisition unit 202 to be displayed with priority on second piloting terminal 50. Priority display control unit 203 also causes information regarding the flight of the flying flight vehicle 10 to be displayed on second piloting terminal 50.

First communication unit 204 performs communication with first piloting terminal 30 for wirelessly piloting flight vehicle 10. Second communication unit 205 performs communication with second piloting terminal 50 for piloting flight vehicle 10 via network 60. Determination unit 206 determines whether first piloting terminal 30 or second piloting terminal 50 is to pilot flight vehicle 10, based on information that first communication unit 204 received from first piloting terminal 30. More specifically, determination unit 206 specifies a piloting experience level corresponding to first piloting terminal 30 based on information that first communication unit 204 received from first piloting terminal 30, and makes the aforementioned determination based on the specified experience level.

In a case of a determination that second piloting terminal 50 is to pilot flight vehicle 10, remote control unit 207 transfers instructions for flight vehicle 10 that were received from second piloting terminal 50 to flight vehicle 10. More specifically, in a case of a determination that second piloting terminal 50 is to pilot flight vehicle 10, remote control unit 207 uses first communication unit 204 to notify first piloting terminal 30 that flight vehicle 10 is to be piloted by second piloting terminal 50, and upon receiving permission in response to the notification, transfers instructions for flight vehicle 10 received from second piloting terminal 50 to flight vehicle 10. In this way, flight vehicle 10 flies in accordance with instructions from first piloting terminal 30 in some cases, and flies in accordance with instructions from second piloting terminal 50 in other cases.

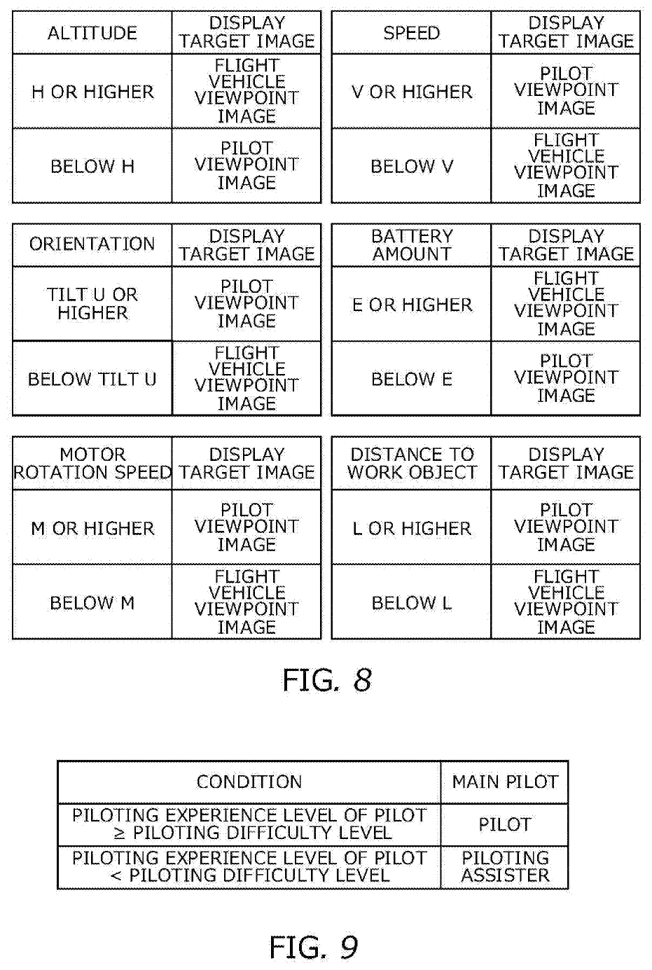

FIG. 8 shows an example of a display image determination table having described therein conditions for determining whether either flight vehicle viewpoint images or pilot viewpoint images are to be displayed with priority in the second piloting terminal. The display image determination table is stored in storage 23 of server apparatus 20. Priority display control unit 203 determines which captured images are to be displayed with priority based on information regarding the flight of flight vehicle 10, and in the present embodiment in particular, priority display control unit 203 determines which captured images are to be displayed with priority based on an in-flight state of flight vehicle 10.

Here, in-flight states include states detected by sensor 18 of flight vehicle 10, such as the altitude, speed, orientation, battery amount, and motor rotation speeds of flight vehicle 10, as well as the distance to the work object. For example, in the case of determining which captured images are to be displayed based on the condition “altitude”, the flight vehicle viewpoint images are displayed with priority if the altitude of flight vehicle 10 is greater than or equal to a threshold value H, and the pilot viewpoint images are displayed with priority if the altitude is less than the threshold value H. In other words, when the altitude of flight vehicle 10 is considered to be the condition, the determination of which captured images are to be displayed with priority is made from the viewpoint of whether the piloting assister can more easily provide assistance while viewing the flight vehicle viewpoint images or while viewing the pilot viewpoint images. According to this viewpoint, the determination of which captured images are to be displayed with priority is made in consideration of conditions other than altitude as well, namely the speed, orientation, battery amount, and motor rotation speeds of flight vehicle 10, and the distance to the work object.

FIG. 9 shows an example of a main pilot determination table having described therein conditions for determining whether first piloting terminal 30 or second piloting terminal 50 is to be the main pilot. The main pilot determination table is stored in the storage 23 of server apparatus 20. Based on information that first communication unit 204 received from first piloting terminal 30, determination unit 206 specifies the piloting experience level of the pilot and the difficulty level of the piloting performed by the pilot, determines that the pilot is to be the main pilot if the piloting experience level of the pilot is greater than or equal to the piloting difficulty level, and determines that the piloting assister is to be the main pilot if the piloting experience level of the pilot is less than the piloting difficulty level. Operations

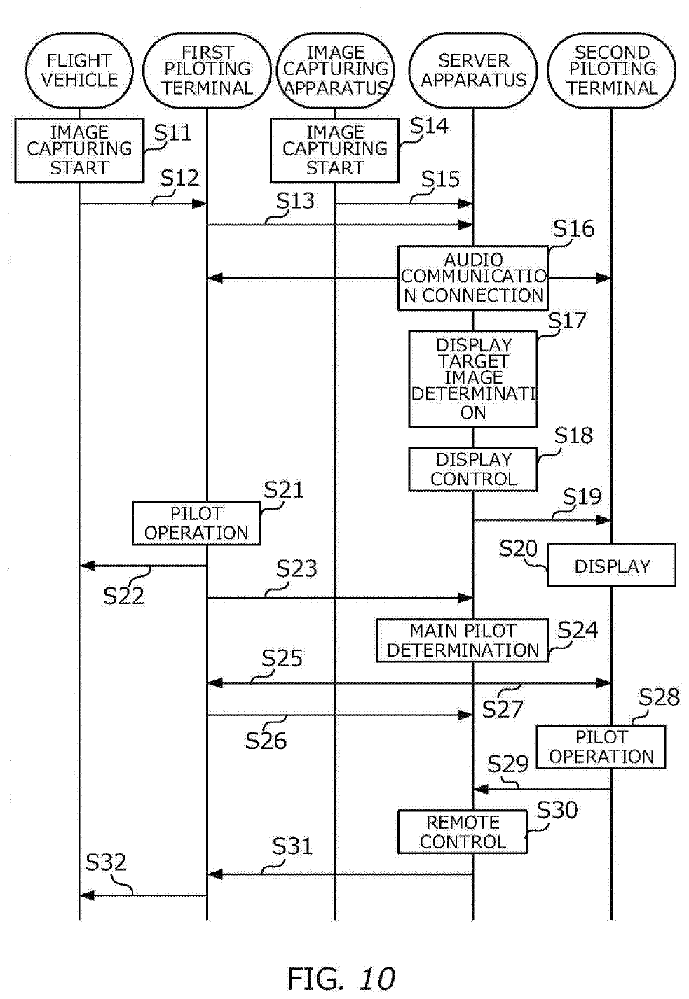

FIG. 10 is a sequence chart showing an example of operations of flight control system 1. In cases where it is described that flight vehicle 10 is performing processing in the following description, this specifically means that processing is executed by predetermined software (program) being loaded to hardware such as processor 11 and memory 12, such that processor 11 performs arithmetic computation and controls communication performed by communication apparatus 14 and the reading and/or writing of data from/to memory 12 and storage 13. The same follows for server apparatus 20, first piloting terminal 30, and second piloting terminal 50 as well.

When flight vehicle 10 starts to fly, image capturing apparatus 16 of flight vehicle 10 starts to capture images (step S11). Moving image data including the captured images is wirelessly transmitted from communication apparatus 14 of flight vehicle 10 to first piloting terminal 30 (step S12). At this time, flight vehicle 10 wirelessly transmits, from communication apparatus 14 to first piloting terminal 30, flight-related information that was detected by positioning apparatus 15 and sensor 18 (including the date/time, the position of flight vehicle 10, the altitude of flight vehicle 10, the speed of flight vehicle 10, the orientation of flight vehicle 10, the battery amount of flight vehicle 10, the motor rotation speeds of flight vehicle 10, the distance between flight vehicle 10 and the work object, and the like). First piloting terminal 30 transmits, to server apparatus 20, the flight-related information and the moving image data including the captured images that were received from flight vehicle 10 (step S13). Note that flight-related information that can be generated by first piloting terminal 30 (e.g., the date/time) may be generated by first piloting terminal 30 and transmitted to server apparatus 20.

Also, image capturing apparatus 40 starts to capture images in accordance with a start imaging operation performed by the pilot (step S14). Moving image data including the captured images is transmitted from image capturing apparatus 40 to server apparatus 20 (step S15). Accordingly, first acquisition unit 201 of server apparatus 20 acquires flight-related information and moving image data including captured images (flight vehicle viewpoint images) from image capturing apparatus 16, and second acquisition unit 202 of server apparatus 20 acquires moving image data including captured images (pilot viewpoint images) from image capturing apparatus 40.

Next, first communication unit 204 and second communication unit 205 of server apparatus 20 relay audio communication between first piloting terminal 30 and second piloting terminal 50 (step S16). Accordingly, the pilot and the piloting assister can communicate through audio. Through this audio communication, the piloting assister can provide advice for assisting the piloting of the pilot.

Priority display control unit 203 of server apparatus 20 references the display image determination table and the flight-related information and determines the captured images that are to be displayed on second piloting terminal 50 (step S17). Specifically, priority display control unit 203 applies the acquired flight-related information to the display image determination table and determines that the display target is the captured images that correspond to such information. At this time, there are cases where the determined captured images differ according to various conditions, such as the flight vehicle viewpoint images being the determined display target if focus is placed on the condition “altitude”, and the pilot viewpoint images being the determined display target if focus is placed on the condition “speed”. At this time, the display target may be determined to be the captured images that match the highest number of conditions, for example. Furthermore, the conditions may be weighted when making a determination. For example, the weight of 1.1 may be assigned for a display target that is determined when focus is placed on the condition “altitude”, and the weight of 1.3 may be assigned for a display target that is determined when focus is placed on the condition “speed”.

Priority display control unit 203 of server apparatus 20 transmits the moving image data that includes the captured images determined to be the display target to second piloting terminal 50, thus performing display control for causing those captured images to be displayed with priority on second piloting terminal 50 (steps S18 and S19). Second piloting terminal 50 displays images in accordance with the moving image data that includes the captured images that were determined to be the display target (step S20). At this time, server apparatus 20 uses second communication unit 205 to transmit, to second piloting terminal 50, information that first communication unit 204 received from first piloting terminal 30 (e.g., the position of flight vehicle 10, the altitude of flight vehicle 10, the speed of flight vehicle 10, the orientation of flight vehicle 10, the battery amount of flight vehicle 10, the motor rotation speeds of flight vehicle 10, the distance between flight vehicle 10 and the work object), and causes such information to be output by audio in second piloting terminal 50. By listening to such audio, the piloting assister can determine the content of the advice for assisting piloting. Note that such information may be displayed on second piloting terminal 50.

The pilot pilots flight vehicle 10 by operating first piloting terminal 30 (step S21). At this time, in first piloting terminal 30, operation instructions for flight vehicle 10 are wirelessly transmitted from first communication apparatus 34 (step S22), and information necessary for specifying the piloting experience level of the pilot of first piloting terminal 30 (e.g., the position of flight vehicle 10 detected by positioning apparatus 15 and sensor 18 of flight vehicle 10, the altitude of flight vehicle 10, the speed of flight vehicle 10, the orientation of flight vehicle 10, the battery amount of flight vehicle 10, the motor rotation speeds of flight vehicle 10, and the distance between flight vehicle 10 and the work object) is transmitted from second communication apparatus 35 to server apparatus 20 (step S23).

First communication unit 204 of server apparatus 20 acquires the above-described information necessary for specifying the piloting experience level of the pilot of first piloting terminal 30. Determination unit 206 determines whether first piloting terminal 30 or second piloting terminal 50 is to be the main pilot of flight vehicle 10, based on the information that first communication unit 204 received from first piloting terminal 30 (step S24).

First, determination unit 206 specifies the piloting experience level with respect to first piloting terminal 30 based on the information that first communication unit 204 received from first piloting terminal 30. For example, in the case where changes in the position of flight vehicle 10, changes in the speed of flight vehicle 10, changes in orientation of flight vehicle 10, and the like are in predetermined ranges, that is to say in the case where there are no rapid changes in the flight of flight vehicle 10, and it can be inferred that reasonable and smooth flight control is being performed, then determination unit 206 determines that the piloting experience level with respect to first piloting terminal 30 is high. However, in the case where changes in the position of flight vehicle 10, changes in the speed of flight vehicle 10, changes in orientation of flight vehicle 10, and the like are outside of the predetermined ranges, that is to say in the case where the flight of flight vehicle 10 is unreasonable, then determination unit 206 determines that the piloting experience level with respect to first piloting terminal 30 is low.

Next, determination unit 206 specifies the difficulty level of the piloting of flight vehicle 10 based on the information that first communication unit 204 received from first piloting terminal 30. For example, the higher the altitude of flight vehicle 10 is, and the smaller the battery amount of flight vehicle 10 is, or the closer the distance between flight vehicle 10 and the work object is, that is to say the higher the match with predetermined conditions deemed to result in difficult piloting of flight vehicle 10 is, then the higher determination unit 206 determines the difficulty level of the piloting of flight vehicle 10 to be. In this way, based on information that first communication unit 204 received from first piloting terminal 30, determination unit 206 specifies the piloting experience level of the pilot and the difficulty level of the piloting performed by the pilot, determines that the pilot is to be the main pilot if the piloting experience level of the pilot is greater than or equal to the piloting difficulty level, and determines that the piloting assister is to be the main pilot if the piloting experience level of the pilot is less than the piloting difficulty level.

Here, in a case where determination unit 206 determined that the main pilot is to be the pilot, piloting of flight vehicle 10 continues to be performed by the pilot with use of first piloting terminal 30. On the other hand, in a case where determination unit 206 determined that the main pilot is to be the piloting assister, piloting of flight vehicle 10 is to be performed by the piloting assister with use of second piloting terminal 50. First, using first communication unit 204, remote control unit 207 notifies first piloting terminal 30 that flight vehicle 10 is to be operated by second piloting terminal 50 (step S25). When this notification is output to first piloting terminal 30, and the pilot performs an operation signifying permission for the notification, first piloting terminal 30 transmits permission for the notification to server apparatus 20 (step S26). Remote control unit 207 notifies second piloting terminal 50 that the main pilot is to be changed from first piloting terminal 30 to second piloting terminal 50 (step S27).

The piloting assister receives the aforementioned notification, and pilots flight vehicle 10 by operating second piloting terminal 50 (step S28). At this time, as previously described, priority display control unit 203 of server apparatus 20 transmits the moving image data that includes the captured images determined to be the display target to second piloting terminal 50, thus performing display control for causing those captured images to be displayed with priority on second piloting terminal 50, and therefore the piloting as sister can pilot flight vehicle 10 while viewing such images. In accordance with operations performed by the piloting assister, second piloting terminal 50 transmits operation instructions for flight vehicle 10 to server apparatus 20 (step S29). Remote control unit 207 of server apparatus 20 transfers operation instructions for flight vehicle 10 that were received from second piloting terminal 50 to flight vehicle 10, thus performing remote control of flight vehicle 10 (steps S30 and S31). Such instructions are transmitted to flight vehicle 10 via first piloting terminal 30 (step S32), and flight vehicle 10 flies in accordance with such instructions. Subsequently, the piloting assister continues to pilot flight vehicle 10 by operating second piloting terminal 50.

According to the embodiment described above, the piloting as sister can easily give piloting assistance from a remote location. Also, images that are appropriate for the piloting assistance are displayed to the piloting assister with priority, thus contributing to the piloting assistance given from a remote location. Variations

The present invention is not limited to the embodiment described above. The above-described embodiment may be modified as described below. Also, two or more of the following variations may be implemented in combination with each other.

### Variation 1

Determination unit 206 determined the main pilot based on information that first communication unit 204 received from first piloting terminal 30, but may determine the main pilot based on information that the second communication unit 205 received from second piloting terminal 50. Specifically, determination unit 206 determines whether first piloting terminal 30 or second piloting terminal 50 is to be the pilot of flight vehicle 10 based on information that first communication unit 204 received from first piloting terminal 30 or information that second communication unit 205 received from second piloting terminal 50. For example, after the main pilot has changed to the piloting assister, if second communication unit 205 acquires information indicating piloting content from second piloting terminal 50, determination unit 206 may specify the difficulty level of the piloting of flight vehicle 10 based on the acquired information, and determine that the main pilot is to be reverted to the pilot if the difficulty level is lower than a pilot piloting experience level that has been specified in advance.

### Variation 2

A configuration is possible in which, instead of operation instructions for flight vehicle 10 that were received from second piloting terminal 50 being transferred to flight vehicle 10 via first piloting terminal 30, in a case where flight vehicle 10 can directly connect to and perform communication on network 60, such operation instructions are transferred to flight vehicle 10 via network 60 without passing through first piloting terminal 30.

### Variation 3

The conditions used when determination unit 206 determines the main pilot are not limited to the examples given in the embodiment. For example, determination unit 206 may specify the flight environment of flight vehicle 10 based on information that first communication unit 204 received from first piloting terminal 30, and make the determination based on the specified flight environment. The flight environment mentioned here includes, for example, wind-related information such as wind direction and wind speed, and weather-related information such as clear sky, clouds, fog, rain, snow, and thunder. First piloting terminal 30 acquires information for specifying such conditions by measurement on its own or from a predetermined measurement apparatus, and transmits the acquired information to server apparatus 20. Determination unit 206 of server apparatus 20 specifies the difficulty level of the flight of flight vehicle 10 based on such flight environment conditions.

### Variation 4

Also, determination unit 206 may specify states of flight vehicle 10 based on information that first communication unit 204 received from first piloting terminal 30, and make the determination based on the specified states, for example. The states of the flight vehicle referred to here are “function problem”, “operation problem”, and the like, and first piloting terminal 30 acquires information for specifying such states by measurement on its own, and transmits the acquired information to server apparatus 20. Determination unit 206 of server apparatus 20 specifies the difficulty level of the flight of flight vehicle 10 based on such flight states. Variation 5

In a case where there are a plurality of piloting assisters for one or more pilots, remote control may be performed as follows. Specifically, in a case where there are a plurality of sets of first piloting terminal 30 and second piloting terminal 50 (when counting the sets, one first piloting terminal 30 may be counted in multiple sets), determination unit 206 determines the main pilot for each set of first piloting terminal 30 and second piloting terminal 50, and, for each set of first piloting terminal 30 and second piloting terminal 50, if it is determined that flight vehicle 10 is to be piloted by second piloting terminal 50, remote control unit 207 transfers instructions for flight vehicle 10 that are received from second piloting terminal 50 to flight vehicle 10. For example, in a case where there are two second piloting terminals 50 (i.e., in a case where there are two piloting assisters), assume that one second piloting terminal 50 is a terminal for assisting the piloting of flight vehicle 10 by the pilot, and that the other second piloting terminal 50 is a terminal for assisting image capturing performed by the pilot with use of flight vehicle 10. In this case, the piloting assisters can each perform operations for image capturing or flight of flight vehicle 10 in accordance with their own assistance objectives by using their second piloting terminals 50 while viewing corresponding images. According to this configuration, it is possible to realize an aspect in which a plurality of piloting assisters can provide piloting assistance to one pilot.

### Variation 6

When images are to be displayed with priority, the conditions for determining the display target captured images are not limited to the example of the embodiment. For example, priority display may be performed in accordance with piloting information regarding piloting operations performed by the pilot on first piloting terminal 30, such as operation amounts, operation directions, and operation frequency. In this example, storage 23 stores a display image determination table having described therein piloting information-related conditions for determining whether the flight vehicle viewpoint images or the pilot viewpoint images are to be displayed with priority. When first acquisition unit 201 acquires the aforementioned pilot piloting-related information from first piloting terminal 30, priority display control unit 203 references the display image determination table based on such information and determines the captured images that are to be displayed with priority. For example, the captured images that are to be displayed with priority are different between cases where the pilot piloting experience level is determined to be high based on the piloting information, or the piloting itself is easy, and cases where the pilot piloting experience level is determined to be low based on the piloting information, or the piloting itself is difficult. According to this configuration, it is possible to realize piloting assistance that corresponds to piloting content.

### Variation 7

Also, the display priority determination may be made in accordance with attributes such as the piloting proficiency or the piloting experience of the pilot or the piloting assister. In this example, storage 23 stores a display image determination table having described therein conditions that are related to attributes of the pilot or the piloting as sister for determining whether the flight vehicle viewpoint images or the pilot viewpoint images are to be displayed with priority. Priority display control unit 203 identifies the pilot or the piloting assister that is logged into the system, references the display image determination table based on the attributes of the identified person, and determines the captured images that are to be displayed with priority. For example, the captured images that are to be displayed with priority are different between cases where, based on the attributes, the pilot piloting experience level is determined to be high, the piloting assister piloting experience is determined to be high, the pilot piloting experience level is determined to be low, and the piloting as sister piloting experience is determined to be low. According to this configuration, it is possible to realize piloting assistance that corresponds to such attributes.

### Variation 8

The display priority determination may be made in accordance with the content of the piloting assistance provided by the piloting as sister. In this example, storage 23 stores a display image determination table having described therein piloting assistance-related conditions for determining whether the flight vehicle viewpoint images or the pilot viewpoint images are to be displayed with priority. Priority display control unit 203 acquires piloting assistance-related information (e.g., high/low assistance level, or assistance complexity/simplicity) provided by the piloting assister from second piloting terminal 50, references the display image determination table based on such information, and determines the captured images that are to be displayed with priority. For example, the captured images that are to be displayed with priority are different between cases where, based on the piloting assistance content, the piloting assistance level is determined to be high, or the piloting assistance itself is easy, and cases where the piloting assistance level is determined to be low, or the piloting assistance itself is difficult. According to this configuration, it is possible to realize piloting assistance that corresponds to such content of piloting assistance.

### Variation 9

In a case where there are a plurality of piloting assisters for one pilot, the priority display determination may be made as follows. Specifically, in a case where there are a plurality of second piloting terminals 50, priority display control unit 203 determines the captured images that are to be displayed with priority in accordance with methods determined for respective second piloting terminals 50. For example, in a case where one second piloting terminal 50 is a terminal for supporting flight of flight vehicle 10 by a pilot, and another second piloting terminal 50 is a terminal for assisting image capturing performed by the pilot with use of flight vehicle 10, it is determined that the images to be displayed with priority on the one second piloting terminal 50 are the pilot viewpoint images, which are more useful for flight assistance, and it is determined that the images to be displayed with priority on the other second piloting terminal 50 are the flight vehicle viewpoint images, which are more useful for image capturing assistance. The piloting assisters thus operate the respective second piloting terminals 50 in accordance with their own assistance objectives while viewing the respective images. According to this configuration, it is possible to realize an aspect in which a plurality of piloting assisters can provide piloting assistance to one pilot. Variation 10

In a case where there are a plurality of flight vehicles 10 and pilots for one piloting assister, the priority display determination may be made as follows. First acquisition unit 201 acquires captured images that were captured by image capturing apparatuses 16 included in the respective flight vehicles 10, and second acquisition unit 202 acquires captured images that show the flight of the respective flight vehicles 10. For each flight vehicle 10, priority display control unit 203 selects the captured images acquired by first acquisition unit 201 or the captured images acquired by second acquisition unit 202 in accordance with the objective of piloting assistance for each pilot, and causes the selected captured images to be displayed with priority on the terminal in the possession of the piloting assister. For example, in a case of providing flight assistance for first flight vehicle 10 to one first piloting terminal 30, and providing image capturing assistance for second flight vehicle 10 to another first piloting terminal 30, when providing assistance to the one first piloting terminal 30, the captured images that are displayed with priority on the one second piloting terminal 50 are the pilot viewpoint images that show the flight of first flight vehicle 10, and when providing assistance to the other first piloting terminal 30, the captured images that are displayed with priority on the one second piloting terminal 50 are the flight vehicle viewpoint images that were captured by second flight vehicle 10. By operating second piloting terminal 50 while viewing these images, the one piloting assister can provide assistance to two pilots at the same time or alternatingly. According to this configuration, it is possible to realize a case where one piloting assister provides piloting assistance to a plurality of pilots.

### Variation 11

Information related to latency in network 60 may be displayed on second piloting terminal 50. In other words, priority display control unit 203 may cause information related to delay in data communication between own server apparatus 20 and second piloting terminal 50 to be displayed on second piloting terminal 50. Such information is also useful in piloting assistance.

### Variation 12

Captured images designated by the piloting assister may be displayed with priority on second piloting terminal 50. The captured images that are to be displayed with priority on second piloting terminal 50 may be determined in consideration of the weather forecast.

### Variation 13

Any method may be used to follow flight vehicle 10 while capturing images. Also, the method for measuring the position of flight vehicle 10 is not limited to a method employing GPS, and any method may be used. Also, a configuration is possible in which flight vehicle 10 is configured to be capable of performing communication via network 60, and flight vehicle 10 performs communication with server apparatus 20 or second piloting terminal 50 without passing through first piloting terminal 30.

### Other Variations

The block diagrams used in the above description of the embodiments shows blocks in units of functions. These functional blocks (configuration units) are realized by any combination of hardware and/or software. Furthermore, there are no particular limitations on the means for realizing the functional blocks. In other words, the functional blocks may be realized by one physically and/or logically combined apparatus, or a plurality of physically and/or logically separated apparatuses that are connected directly and/or indirectly (for example, in a wired and/or wireless manner). Also, at least some of the functions of server apparatus 20 may be implemented in first piloting terminal 30 or second piloting terminal 50. Similarly, at least some of the functions of first piloting terminal 30 or second piloting terminal 50 may be implemented in server apparatus 20.

The aspects/embodiments explained in the present description may also be applied to a system using Long Term Evolution (LTE), LTE-Advanced (LTE-A), SUPER 3G, IMT-Advanced, 4G, 5G, Future Radio Access (FRA), W-CDMA (registered trademark), GSM (registered trademark), CDMA2000, Ultra Mobile Broadband (UMB), IEEE 802.11 (Wi-Fi), IEEE 802.16 (WiMAX), IEEE 802.20, Ultra-Wide Band (UWB), Bluetooth (registered trademark) or another appropriate system, and/or an extended next-generation system that is based on them.

The orders in the processing procedures, sequences, flowcharts, and the like of the aspects/embodiments described in the present description may be changed as long as no contradictions arise. For example, the methods explained in the present description show various step elements in an exemplified order, and are not limited to the specific order that is shown.

The aspects/embodiments described in the present description may also be used alone or in combination, or may also be switched when they are implemented. Furthermore, the notification of predetermined information (e.g., notification of “being X”) is not limited to being performed explicitly, and may also be performed implicitly (for example, notification of the predetermined information is not performed).

The terms “system” and “network” used in the present description can be used in an interchangeable manner.

The information and the parameters described in the present description may also be expressed by absolute values, relative values with respect to a predetermined value, or another type of corresponding information. For example, a radio resource may also be one indicated by an index.

The names used for the above-described parameters are in no way limiting. Furthermore, there may be a case where formulae and the like using these parameters are different from those explicitly disclosed in the present description. Various channels (such as, for example, a PUCCH and a PDCCH) and information elements (such as, for example, a TPC) can be identified by any suitable name, and thus various names assigned to these various channels and information elements are no way limiting.

The term “determining” used in the present description may include various types of operations. The term “determining” can include a case where judging, calculating, computing, processing, deriving, investigating, looking up (for example, looking up a table, a data base, or another data structure), or ascertaining is regarded as “determining”. Furthermore, the term “determining” can include a case where receiving (for example, receiving information), transmitting (for example, transmitting information), inputting, outputting, or accessing (for example, accessing data in the memory) is regarded as “determining”. Furthermore, the term “determining” can include a case where resolving, selecting, choosing, establishing, or comparing is regarded as “determining”. In other words, the term “determining” can include a case where some operation is regarded as “determining”.

The present invention may be provided as a flight control method that includes the processing steps performed in flight control system 1. Also, the present invention may be provided as a program that is executed in server apparatus 20, flight vehicle 10, first piloting terminal 30, or second piloting terminal 50. This program may be provided in an aspect of being recorded on a recording medium such as an optical disk, or may be provided in an aspect of being downloaded to a computer via a network such as the Internet and being installed in the computer to become usable, for example.

Software, instructions, and the like may also be transmitted/received via a transmission medium. For example, if software is transmitted from a web site, a server, or another remote source using a wired technology such as a coaxial cable, an optical fiber cable, a twisted-pair wire, or a digital subscriber line (DSL), and/or a wireless technology using infrared light, radio waves, microwaves, or the like, the definition of the transmission medium will include the wired technology and/or the wireless technology.

Information, signals, and the like described in the present description may also be expressed using any of various different technologies. For example, data, an instruction, a command, information, a signal, a bit, a symbol, a chip, and the like that may be mentioned throughout the entire description above may also be expressed by an electric voltage, an electric current, an electromagnetic wave, a magnetic field or a magnetic particle, an optical field or a photon, or an arbitrary combination thereof.

Note that the terms described in the present description and/or the terms needed for understanding the present description may also be replaced by terms that have the same or similar meaning. For example, a channel and/or a symbol may also be a signal. Furthermore, a signal may also be a message. Furthermore, a component carrier (CC) may also be referred to as a carrier frequency, a cell, or the like.

All references to elements that have been given names such as “first” and “second” in the present description do not overall limit the number of such elements or the orders thereof. Such names may be used in the present description as a convenient method for distinguishing between two or more elements. Accordingly, references to first and second elements are not intended to mean that only two elements can be employed, or that the first element is required to come before the second element in some sort of manner.

The “means” in the configurations of the above-described apparatuses may be replaced by “unit”, “circuit”, “device”, or the like.

The terms “including”, “comprising”, and other forms thereof are intended to be comprehensive as long as they are used in the present description or the claims, similar to the term “being provided with”. Furthermore, the term “or” used in the present description or the claims is intended not to be exclusive OR.

In the entirety of the present disclosure, when articles are added through translation, for example, as “a”, “an”, and “the” in English, these articles also denote the plural form unless it is clear otherwise from the context.

While the present invention has been described in detail, it would be obvious to those skilled in the art that the present invention is not limited to the embodiments explained in the present description. The present invention can be implemented as corrected and modified aspects without departing from the spirit and scope of the present invention that are defined by the description of the claims. Accordingly, the present description aims to illustrate examples and is not intended to restrict the present invention in any way.

### REFERENCE SIGNS LIST

1 flight control system

10 flight vehicle

20 server apparatus

21 processor

22 memory

23 storage

24 communication apparatus

200 tracking unit

201 first acquisition unit

202 second acquisition unit

203 priority display control unit

204 first communication unit

205 second communication unit

206 determination unit

207 remote control unit

30 first piloting terminal

40 image capturing apparatus

50 second piloting terminal.

“what is claimed is:”

1.-8. (canceled)

9. An information processing apparatus comprising:
a first communication unit configured to perform communication with a first piloting terminal that is for wirelessly piloting a flight vehicle;
a second communication unit configured to perform communication with a second piloting terminal that is for piloting the flight vehicle via a network;
a determination unit configured to determine whether the first piloting terminal or the second piloting terminal is to pilot the flight vehicle based on information that the first communication unit receives from the first piloting terminal or information that the second communication unit receives from the second piloting terminal; and
a remote control unit configured to, in a case where it is determined that the second piloting terminal is to pilot the flight vehicle, transfer an instruction for an operation of the flight vehicle that is received from the second piloting terminal to the flight vehicle.

10. The information processing apparatus according to claim 9,
wherein in a case where it is determined that the second piloting terminal is to pilot the flight vehicle, the remote control unit uses the first communication unit to notify the first piloting terminal that the second piloting terminal is to pilot the flight vehicle, and if permission is received in response to the notification, the remote control unit transfers the instruction for the flight vehicle that is received from the second piloting terminal to the flight vehicle.

11. The information processing apparatus according to claim 9,
wherein the determination unit specifies a piloting experience level with respect to the first piloting terminal based on information that the first communication unit receives from the first piloting terminal or information that the second communication unit receives from the second piloting terminal, and makes the determination based on the experience level.

12. The information processing apparatus according to claim 9,
wherein the determination unit specifies a flight environment of the flight vehicle based on information that the first communication unit receives from the first piloting terminal, and makes the determination based on the flight environment.

13. The information processing apparatus according to claim 9,
wherein the determination unit specifies a state of the flight vehicle based on information that the first communication unit receives from the first piloting terminal, and makes the determination based on the state.

14. The information processing apparatus according to claim 9,
wherein the first communication unit and the second communication unit relay audio communication between the first piloting terminal and the second piloting terminal, and
information that the first communication unit receives from the first piloting terminal is output by audio with use of the second communication unit.

15. The information processing apparatus according to claim 9,
in a case where there are a plurality of sets of the first piloting terminal and the second piloting terminal, the determination unit makes the determination for each set of the first piloting terminal and the second piloting terminal, and
for each set of the first piloting terminal and the second piloting terminal, in a case where it is determined that the second piloting terminal is to pilot the flight vehicle, the remote control unit transfers the instruction for the flight vehicle that is received from the second piloting terminal to the flight vehicle.

16. A flight control system comprising:
a first piloting terminal for wirelessly piloting a flight vehicle;
a second piloting terminal for piloting the flight vehicle via a network;
a first communication unit configured to perform communication with the first piloting terminal;
a second communication unit configured to perform communication with the second piloting terminal;
a determination unit configured to determine whether the first piloting terminal or the second piloting terminal is to pilot the flight vehicle based on information that the first communication unit receives from the first piloting terminal or information that the second communication unit receives from the second piloting terminal; and
a remote control unit configured to, in a case where it is determined that the second piloting terminal is to pilot the flight vehicle, transfer an instruction for an operation of the flight vehicle that is received from the second piloting terminal to the flight vehicle.
